(19) United States
(12) Patent Application Publication
(10) Pub. No.: US 2022/0087113 A1
(43) Pub. Date: Mar. 24, 2022

(54) SYSTEMS AND METHODS FOR SYNERGISTIC HORTICULTURAL REGIMENS USING CONTROLLED WIND AND LIGHT EXPOSURE FOR STRENGTHENED, PLANT IMMUNE SYSTEMS AND PLANT FUNGI TREATMENTS

(71) Applicant: Growor, Inc., Lewes, DE (US)

(72) Inventors: Michael Naich, Herzliya (IL); Daniel Levin, Tel Aviv (IL)

(21) Appl. No.: 17/478,922

(22) Filed: Sep. 19, 2021

Related U.S. Application Data
(60) Provisional application No. 63/081,977, filed on Sep. 23, 2020.

(51) Int. Cl. A01G 7/04; A01G 13/08

(52) U.S. Cl. CPC A01G 7/045; A01G 13/08

(57) ABSTRACT

The present invention discloses systems and methods for synergistic horticultural regimens. Methods include the steps of: providing a plant in a controlled environment for regulating wind and light exposure at a temperature and relative humidity (RH) in the vicinity of the plant; exposing the plant to a breeze in order to cause swaying to induce microcracks in the plant; exposing the plant to a first light spectrum of about 360-445 nm to stimulate exudate formation; increasing the temperature to about 22-32° C.; removing the breeze after the plant is covered with an exudate; exposing the plant to a second light spectrum of about 360-445 nm and about 425-480 nm; reducing the temperature to about 22-25° C. and the RH to 30-60%; and exposing the plant to a third light spectrum of about 650 nm and 730 nm to cause the exudate to release oxygen during hardening of the exudate on the plant.

### CROSS REFERENCE TO RELATED APPLICATIONS

This patent application claims priority under 35 U.S.C. § 119(e) to U.S. Provisional Patent Application No. 63/081,977, filed Sep. 23, 2020, which is hereby incorporated by reference in its entirety.

### FIELD AND BACKGROUND OF THE INVENTION

The present invention relates to systems and methods for synergistic horticultural regimens using controlled wind and light exposure for strengthened, plant immune systems and plant fungi treatments. In particular, the present invention relates to the fields of agriculture, plant growth methodology, and plant development regulation via a combination of wind and light exposure regimens for growing plants and seedlings in greenhouses.

Fungi (including molds) are a big problem for almost all cultivators. Fungi can exist as unicellular microscopic organisms called yeasts, as multicellular microscopic molds with hyphae, or as macroscopic mushrooms with a visible sexual organ, the fruiting body. Molds, on the other hand, are multicellular microscopic fungi, typically characterized by the presence of hyphae filaments.

Means for dealing with fungi usually involve various chemical agents, which can be extremely detrimental to crops, especially for crops whose fruits or leaves enter the human food chain. In addition, fungi impair plant productivity, and can rapidly spread to impact an entire greenhouse. In the early stages of development, fungi and molds are almost impossible to detect.

It is difficult to avoid fungal infections in plants without preventative measures. Spores live in soil, air, water, and in other surrounding plants, and are carried by the wind, animals, and even people. Growing mycelia penetrate the plant tissue, and begin to devour living matter. In addition, leaves covered with the fungus do not receive light and die as a result without the ability to perform photosynthesis. In medicine and biology in general, light therapy as a way of influencing living organisms has led to the development of devices and methods for providing therapeutic and stimulating effects.

In the prior art, known electron-optical emitting devices that can be used for beneficial effects of visible light on living organisms (e.g., people, animals, and plants) include RU Patent Nos. 157209, 2196622, and DE Patent No. 3220218. However, such techniques are not very effective.

The non-invasive method of pulsed-light therapy for photo-stimulation of plants and microorganisms (RU Patent No. 2640851) teaches irradiating plants with light pulses in the ultraviolet wavelength range of 305-405 nm, while also irradiating in the red and infrared ranges of the spectrum with an irradiation ratio in the three spectral regions of 97:1.5:1.5. Another prior-art technique (RU Patent No. 2504143) teaches using LEDs in a greenhouse, while RU Patent No. 2118186 teaches a method for treating disease using pulsed irradiation in the UV spectral range of 250-400 nm over the patient's body, causing mechanical stress in the irradiated zone of the subject.

A publication on “Ongoing Growth Challenges Fruit Skin Integrity” (Moritz Knoche and Alexander Lang, Critical Reviews in Plant Sciences, 36:3, p. 190-215 (2017)) teaches that the skins of most fruit species suffer ongoing strain throughout development as a result of continuing volume and hence surface-area growth. Maintenance of surface integrity is essential to protect the underlying tissues from desiccation and pathogen attack. Skin failure can be just of the cuticle layer (microcracking) resulting in barrier impairment, or it can involve cuticle and cellular layers (macrocracking) resulting in both barrier and structural impairment. Fruit skin failure is associated with a number of disorders including shriveling, cracking, russeting, and skin spots.

The United States Geological Survey (USGS) published on its website (www.usgs.gov) an overview on the topic of “Evapotranspiration and the Water Cycle.” Evapotranspiration is the sum of evaporation from the land surface plus transpiration from plants. Transpiration is the process of water movement through a plant and its evaporation from aerial parts, such as leaves, stems, and flowers. The USGS article describes the effect of wind on transpiration. The increased movement of the air around a plant results in a higher transpiration rate. Wind moves the air around, with the result that the more saturated air close to the leaf is replaced by drier air.

The Tree Care Industry Association (TCIA) on its website (www.tcia.org) in an article on “Cracks Can Cause Hazards in Trees” noted that most cracks are caused by improper closure of wounds or by the splitting of weak branch unions.

WO Patent Publication No. 2019/180722 discloses methods for obtaining a plant exudate by inducing the plant to secrete an exudate and systems for the collection of a plant exudate.

It would be desirable to have systems and methods for synergistic horticultural regimens using controlled wind and light exposure for strengthened, plant immune systems and plant fungi treatments. Such systems and methods would, inter alia, overcome the various limitations mentioned above.

### SUMMARY

It is the purpose of the present invention to provide systems and methods for synergistic horticultural regimens using controlled wind and light exposure for strengthened, plant immune systems and plant fungi treatments.

It is noted that the term “exemplary” is used herein to refer to examples of embodiments and/or implementations, and is not meant to necessarily convey a more-desirable use-case. Similarly, the terms “alternative” and “alternatively” are used herein to refer to an example out of an assortment of contemplated embodiments and/or implementations, and is not meant to necessarily convey a more-desirable use-case. Therefore, it is understood from the above that “exemplary” and “alternative” may be applied herein to multiple embodiments and/or implementations. Various combinations of such alternative and/or exemplary embodiments are also contemplated herein.

Embodiments of the present invention provide highly-effective systems and methods for influencing the wind flow and light exposure on plants in order to mitigate fungi/molds on plants. Such methods, in turn, can increase the quantity (i.e., yield) and quality of a crop.

In plants, the transpiration stream is the uninterrupted stream of water and solutes which is taken up by the roots and transported via the xylem to the leaves where it evaporates into the air/apoplast-interface of the substomatal cavity. Transpiration can be regulated through stomatal closure or opening. It allows for plants to efficiently transport water up to their highest body organs, and regulate the temperature of stem and leaves.

Stomata are small pores on the top and or bottom of a leaf that are responsible for taking in CO₂ and expelling water vapor. Plants regulate the rate of transpiration by controlling the size of the stomatal apertures. The rate of transpiration is also influenced by the evaporative demand of the atmosphere surrounding the leaf such as boundary layer conductance, humidity, temperature, wind, and incident sunlight. In general, light exposure encourages open stomata. Stomatal conductance, usually measured in mmol m⁻² s⁻¹, is the measure of the rate of passage of carbon dioxide (CO₂) entering, or water vapor exiting through the stomata of a leaf.

Light-dependent stomatal opening occurs in many species and under many different conditions. Light is a major stimulus involved in stomatal conductance, and has two key elements that are involved in the process: the stomatal response to blue light, and photosynthesis in the guard cell's chloroplast. The stomata open when there is an increase in light, and they close when there is a decrease in light. This is because the blue light activates a receptor on the guard cell membrane which induces the pumping of protons of the cells, which creates an electrochemical gradient.

Embodiments of the present invention provide synergistic horticultural regimens using controlled wind and light exposure for strengthened, plant immune systems and plant fungi treatments. Alternating exposure of plant surfaces to controlled wind and light regimens, within a prescribed emission spectra and exposure duration, enables such treatment of greenhouse plants affected by fungi.

Before light irradiation, a stressful situation for the plants is created by providing a breeze to moderately sway the plants. Random changes in the direction and strength of the air movement prevent the plants from finding a balanced stress compensation, which increases the release of ethylene and increases the activity of acids. The induced stress on the plants causes the release of an exudate. An exudate is any substance that oozes out from the pores of diseased or injured plant tissue.

Ethylene release is caused by an increase in the activity of synthetase, which catalyzes a key ethylene biosynthesis reaction. An accumulation of phenolic growth inhibitors (chlorogenic acid, flavonoids, and phenolcarboxylic acids—a type of phytochemical called a polyphenol) was found to be present under these conditions. This contributes to the creation of the exudate in the form of a type of polymer film, which dries and creates a thin layer through which oxygen does not pass.

The release of exudate is further stimulated with light exposure to a “soft” or solar UV spectral region, while simultaneously increasing the ambient temperature over a controlled time interval. A subsequent light exposure to a blue spectral region is then performed while lowering the temperature and humidity over a controlled time interval. The plants are then simultaneously exposed to light in the red and infrared spectral regions over a controlled time interval.

As a result of the sequential, synergistic horticultural regimens described above, the exudate film hardens, which is accompanied by the exudate layer becomes denser through the loss of oxygen. Fungi or molds present on the plants are then covered with a layer of the hardened exudate, and die due to a lack of oxygen. As a result of natural plant growth, after a couple of days, the exudate film is naturally destroyed, and the dead mushrooms and molds disappear.

Therefore, according to the present invention, there is provided for the first time a system for synergistic horticultural regimens using controlled wind and light exposure for strengthened, plant immune systems and plant fungi treatments, the system including: (a) at least one LED lighting system for facilitating prescribed light exposure regimens, capable of achieving a high Photon Flux Density (PFD) at various desirable wavelengths; (b) at least one controllable fan unit for modulating a controlled breeze of forced air flow in a controlled environment having an ambient temperature and relative humidity (RH) in the vicinity of at least one plant; (c) at least one sensor unit for monitoring and regulating the ambient temperature and the RH; (d) a remote controller for regulating wind and lighting parameters by measuring and regulating at least one LED lighting system, at least one controllable fan unit, and at least one sensor unit, the remote controller configured for: (i) exposing at least one plant to the controlled breeze in order to cause swaying of at least one plant to induce microcracks in at least one plant; (ii) exposing at least one plant to a first light regimen in a spectral region of about 360-445 nm to stimulate exudate formation in at least one plant; (iii) concurrent with the first light regimen, increasing the ambient temperature to about 22-32° C.; (iv) removing the controlled breeze after the exterior surfaces of at least one plant are mostly covered with an exudate; (v) exposing at least one plant to a second light regimen in spectral regions of about 360-445 nm and about 425-480 nm to stabilize internal plant processes and to inhibit growth in order to maximize spread and uniform distribution of the exudate; (vi) subsequent to the removing, reducing the ambient temperature to about 22-25° C.; (vii) subsequent to the removing, reducing the RH to about 30-60%; and (viii) exposing at least one plant to a third light regimen in spectral regions of about 650 nm and about 730 nm to cause the exudate to release oxygen during hardening of the exudate on at least one plant.

Alternatively, the controlled environment is adapted to be maintained with the ambient temperature in the range of about 20-22° C. and with the RH in the range of about 40-80%.

Alternatively, the first light regimen has an exposure time of about 10 minutes.

Most alternatively, the increasing is adapted to maintain the ambient temperature for a duration equivalent to the exposure time.

Alternatively, the second light regimen has an exposure time of at least about 15-30 minutes.

Alternatively, the reducing the ambient temperature and the reducing the RH is performed within about 30 minutes of the removing.

Alternatively, the third light regimen has an exposure time of at least about 30 minutes.

Most alternatively, the remote controller is further configured for: (ix) exposing at least one plant to a fourth light regimen in a spectral region of about 730 nm for about 18-33 minutes longer in duration than the exposure time.

According to the present invention, there is provided for the first time a method for synergistic horticultural regimens using controlled wind and light exposure for strengthened, plant immune systems and plant fungi treatments, the method including the steps of: (a) providing at least one plant in a controlled environment for regulating wind and light exposure at an ambient temperature and relative humidity (RH) in the vicinity of at least one plant; (b) exposing at least one plant to a controlled breeze in order to cause swaying of at least one plant to induce microcracks in at least one plant; (c) exposing at least one plant to a first light regimen in a spectral region of about 360-445 nm to stimulate exudate formation in at least one plant; (d) concurrent with the first light regimen, increasing the ambient temperature to about 22-32° C.; (e) removing the controlled breeze after the exterior surfaces of at least one plant are mostly covered with an exudate; (f) exposing at least one plant to a second light regimen in spectral regions of about 360-445 nm and about 425-480 nm to stabilize internal plant processes and to inhibit growth in order to maximize spread and uniform distribution of the exudate; (g) subsequent to the step of removing, reducing the ambient temperature to about 22-25° C.; (h) subsequent to the step of removing, reducing the RH to about 30-60%; and (i) exposing at least one plant to a third light regimen in spectral regions of about 650 nm and about 730 nm to cause the exudate to release oxygen during hardening of the exudate on at least one plant.

Alternatively, the controlled environment is adapted to be maintained with the ambient temperature in the range of about 20-22° C. and with the RH in the range of about 40-80%.

Alternatively, the first light regimen has an exposure time of about 10 minutes.

Most alternatively, the step of increasing is adapted to maintain the ambient temperature for a duration equivalent to the exposure time.

Alternatively, the second light regimen has an exposure time of at least about 30 minutes.

Alternatively, the step of reducing the ambient temperature and the step of reducing the RH is performed within about 30 minutes of the step of removing.

Alternatively, the third light regimen has an exposure time of at least about 30 minutes.

Most alternatively, the method further includes the step of: (j) exposing at least one plant to a fourth light regimen in a spectral region of about 730 nm for about 18-33 minutes longer in duration than the exposure time.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 is a simplified high-level schematic diagram of the system architecture for synergistic horticultural regimens using controlled wind and light exposure for strengthened, plant immune systems and plant fungi treatments, according to embodiments of the present invention;

FIG. 2 is a simplified high-level schematic diagram of the system architecture of FIG. 1 deployed in a typical plant-bed greenhouse layout, according to embodiments of the present invention;

FIG. 3 is a simplified flowchart of the major process steps for synergistic horticultural regimens using controlled wind and light exposure for strengthened, plant immune systems and plant fungi treatments, according to embodiments of the present invention.

### DESCRIPTION OF THE ILLUSTRATIVE EMBODIMENTS

The present invention relates to systems and methods for synergistic horticultural regimens using controlled wind and light exposure for strengthened, plant immune systems and plant fungi treatments. The principles and operation for providing such systems and methods, according to the present invention, may be better understood with reference to the accompanying description and the drawings.

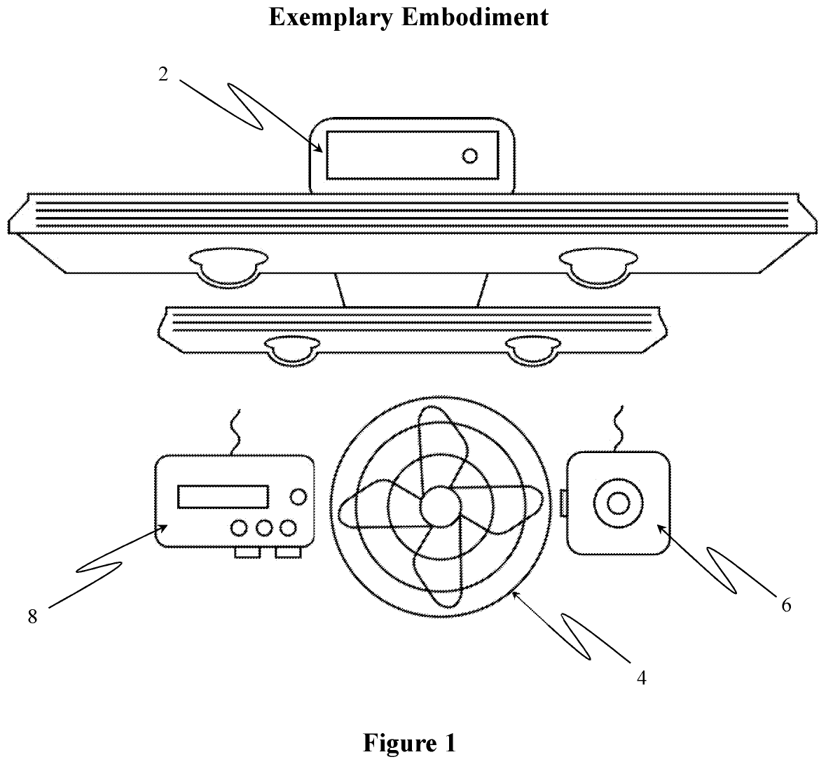

Referring to the drawings, FIG. 1 is a simplified high-level schematic diagram of the system architecture for synergistic horticultural regimens using controlled wind and light exposure for strengthened, plant immune systems and plant fungi treatments, according to embodiments of the present invention. An LED lighting system 2 is shown for facilitating the prescribed light exposure regimens, capable of achieving a high Photon Flux Density (PFD) at various desirable wavelengths.

Controllable fan units 4 are shown for modulating a breeze of forced air flow in greenhouse environments. Sensor units 6 are shown for monitoring and regulating environmental conditions such as temperature and humidity. A remote controller 8 is shown for regulating wind and lighting parameters, measuring and regulating sensor units 6, as well as controlling other greenhouse conditions (e.g., environmental sensors, humidifiers, and dehumidifiers).

LED lighting system 2 is required to have a suitable PFD for: “soft” or solar UV spectral regions of violet (about 360-445 nm), blue (about 425-480 nm with a main peak at about 450-460 nm), and red and infrared (about 630-750 nm with main peaks at about 635 nm, 650-660 nm, and 725-735 nm). Associated therapeutic effects depend on wavelength, PFD, and radiation dose.

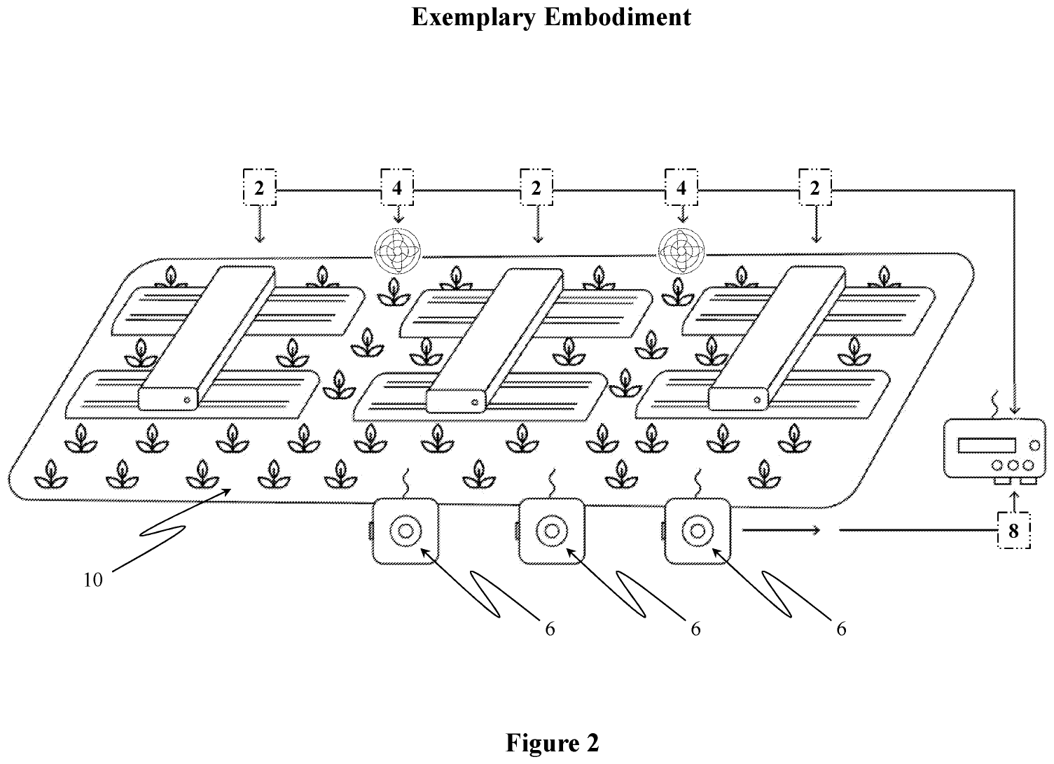

FIG. 2 is a simplified high-level schematic diagram of the system architecture of FIG. 1 deployed in a typical plant-bed greenhouse layout, according to embodiments of the present invention. A typical greenhouse layout is shown with plant beds 10. The main task of properly-equipped greenhouses is to maintain the necessary conditions for the development of the plants in the plant beds. To achieve the optimal environment, two central greenhouse conditions are used: ventilation and lighting.

Plant life is impossible without air. Proper ventilation with the help of an air circulation/ventilation system leads to healthy plants and a large crop. In the event of insufficient air exchange, a dead-air zone forms around the plants. Therefore, it is necessary to constantly move the air. Proper air circulation can prevent molds and parasites. Mold fungi do not grow when fans set create air movement. Insects and ticks cannot manage in such a microclimate, which “bombards” the creatures with air currents.

Controllable fan units 4 can be of numerous types of circulation/ventilation units. The main requirement is that controllable fan units 4 must adequately handle the tasks of “updating” the air over plant beds 10 in the greenhouse (which includes localized circulation as well as ventilation) and removing heat from LED lighting system 2. Controllable fan units 4 must maintain a constant temperature in the range of about 20-22° C. with a relative humidity (RH) of about 40-80%. Such aspects can be measured by sensor units 6, and then regulated by remote controller 8.

RH control also prevents mold and disease. An RH level above 80% keeps ticks away, but contributes to the formation of molds and rotting of the roots and stems. A RH level below 60% reduces the likelihood of rotting and molds. Regulation of RH enables the exact moisture content in the air to be determined, adjusted, and regulated to the required level.

As an exemplary implementation for controllable fan units 4, a simple embodiment is the use of an exhaust fan of the required power/capacity situated in the right location and an air intake/supply fan to create fresh air flow in the greenhouse. Filtering of the air is also important. A closed ventilation system in greenhouse applications is usually a poorly-performed task. Greenhouses require huge ventilation systems. Fans can be installed at the beginning, middle, or end of a duct system. Installation is possible at any angle relative to the axis of the fan, with multiple fans installed in one system.

Exemplary embodiments of synergistic horticultural regimens using controlled wind and light exposure for strengthened, plant immune systems and plant fungi treatments are provided as follows. Controllable fan units 4, in addition to ensuring air circulation in the greenhouse, also create a stressful situation for plants in plant beds 10. Using controllable fan units 4, a “moderate” breeze (i.e., without causing burns on the leaves of the plants) is applied to sway the plants in plant beds 10 along the garden. Plants desire stability; sudden changes cause stress in plants. Rocking plants back and forth leads to the formation of microcracks (damaged plant tissue) on their exterior. As a reparative response, such swaying plants release an exudate (a viscous resin) from the pores of the microcracks.

Dynamic changes created by modulating the strength and direction of air flow from controllable fan units 4 is important in preventing the plants in plant beds 10 from finding balanced stress compensation, which increases the release of ethylene and increases the activity of acids. Ethylene is released by increasing the activity of synthetase, which catalyzes a key ethylene biosynthesis reaction. An accumulation of phenolic growth inhibitors (chlorogenic acid, flavonoids, phenolcarboxylic acids or polyphenols) was found to be present under these conditions, contributing to the creation of a so-called polymer film in the form of the exudate, which dries and creates a thin layer through which oxygen cannot pass.

In addition, to increase the release of exudate from microcracks, a first light regimen of exposure to a soft UV spectral region of about 360-445 nm (violet) is used to stimulate exudate formation, accompanied by an increase in temperature to about 22-32° C. for a period of about 10 minutes (which can be repeated depending on intensity). Under such conditions, the plant becomes mostly covered by its exudate. After which, controllable fan units 4 can be modulated to produce practically no breeze over the plants in plant beds 10.

A second light regimen, with light exposure to the violet spectrum above continuing, while exposure to a spectral region of about 425-480 nm with a main peak at about 450-460 nm (blue) is added for at least about 30 min. The second light regimen is accompanied by regulating down the temperature and humidity, within about 15-30 min. of removing the breeze, to about 22-25° C. and about 30-60% RH using controllable fan units 4 (including dryers and/or dehumidifiers) and sensor units 6 (e.g., temperature, humidity, pressure, and CO₂ sensors), which can monitor and regulate temperature, humidity, pressure, and CO₂ concentration.

The ideal operational configuration for plant beds 10 inside a greenhouse is for LED lighting system 2 and ballasts to reduce humidity through heat transfer, while sensor units 6 (in particular thermostats) maintain desired temperatures. Controllable fan units 4 and sensor units 6 form a single control device for measuring humidity, which is necessary for growing healthy plants.

At this stage, the plants in plant beds 10 are exposed to a third light regimen of spectral regions of about 650 nm (red) and about 730 nm (infrared) for at least about 30 min. Optionally, the duration of exposure to the “infrared” radiation can be about 18-33 min. longer than the “red” radiation. Violet light has the shortest wavelength and the largest amount of energy in the visible spectrum, while red light has the longest wavelength and the smallest amount of energy in the visible spectrum. The longer the wavelength of visible light, the redder its color appears. Infrared light is lower in energy than that of red light. A significant part of sunlight is in the infrared spectral range. The red and infrared exposure causes oxygen radicals of the exudate to cure of the resin film.

During the interaction of the photosensitizer (i.e., the exudate) and the light, free oxygen radicals are formed while photochemical reactions occur, resulting in microorganisms, fungal hyphae, spores, and altered cells dying. When the exudate hardens, oxygen is released, making the resin layer denser. Fungi or molds present on the plants in plant beds 10 are then covered with a layer of hardened exudate, and die due to a lack of oxygen. As a result of natural plant growth, after a couple of days, the exudate film is naturally destroyed, and dead mushrooms and molds disappear.

The intensity of certain wavelengths of light can be controlled by the type of light sources in LED lighting system 2 used to irradiate the plants in plant beds 10. The arrangement of LEDs in the spectral regions of violet, red, and infrared light can be configured as follows. Periodically, exposure is provided in a modulated mode that involves continuous and sequential exposure of alternating groups of LEDs. The emitting electron-optical devices contain groups of emitting LEDs of different emission spectra. The electron-optical devices are connected to a power supply through the control unit such that the devices are activated one after another for specified durations.

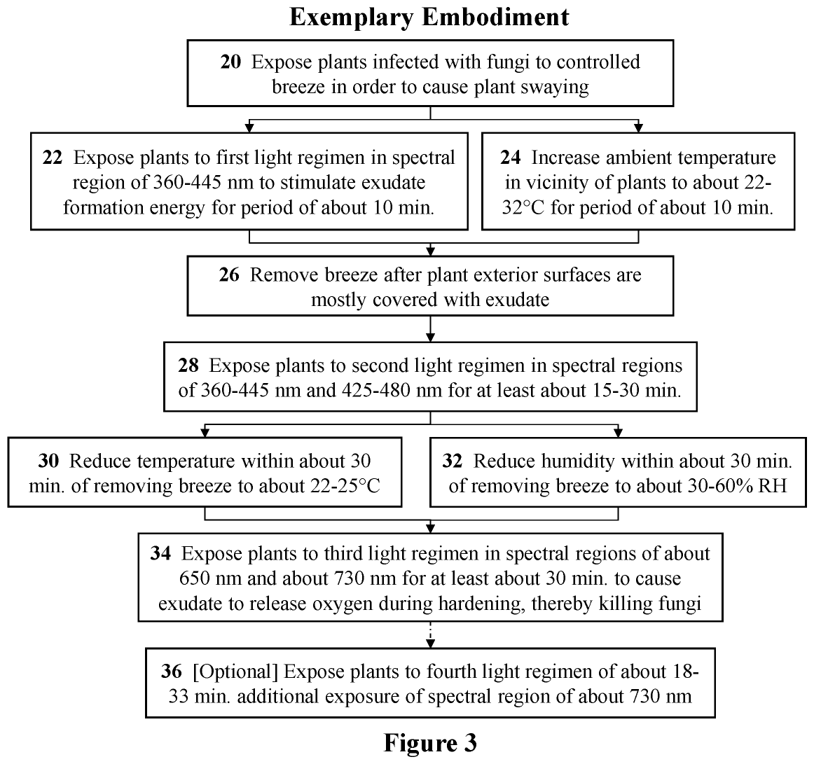

FIG. 3 is a simplified flowchart of the major process steps for synergistic horticultural regimens using controlled wind and light exposure for strengthened, plant immune systems and plant fungi treatments, according to embodiments of the present invention. The process starts with exposing plants infected with fungi to a controlled breeze for a period of about 0.5-3 hrs. in order to cause swaying of the plants (Step 20). It is noted that the plants do not need to be already infected with fungi already in order to apply the treatment; rather, the treatment can also act as a preventative to such fungal infections. The plants are then exposed to a first light regimen in the spectral region of about 360-445 nm to stimulate exudate formation (Step 22), while increasing the ambient temperature in the vicinity of the plants to about 22-32° C. for a period of about 10 minutes (Step 24). The breeze is then removed after the plant exterior surfaces are mostly covered with exudate (Step 26).

The plants are then exposed to a second light regimen in the spectral regions of about 360-445 nm and about 425-480 nm with a main peak at about 450-460 nm for at least about 15-30 min. (Step 28). Within about 30 min. of removing the breeze, the temperature is reduced to about 22-25° C. (Step 30), and the humidity is reduced to about 30-60% RH (Step 32). These wavelengths stabilize internal processes, and inhibit growth in order to maximize the spread of the resulting film and its uniform distribution.

The plants are then exposed to a third light regimen in the spectral regions of about 650 nm and about 730 nm for at least about 30 min. causing the exudate release oxygen during hardening, thereby subsequently killing the fungi (Step 34). Optionally, a fourth light regimen is added, exposing light at about 730 nm for about 18-33 min. longer than the light exposure at about 650 nm (Step 36).

### Experimental Tests

The systems and the synergistic horticultural regimens using controlled wind and light exposure for strengthened, plant immune systems and plant fungi treatments described above were used to conduct experiments on actual greenhouse plant beds. Experiments were conducted on lettuce, tomato, strawberry greenhouse plant beds, as well as on medicinal greenhouse crops. The experiments were carried out on plants at various stages of mold activity. The stages include an early stage in which the first appearance of mold on the plants can be detected, a developed stage in which an abundant amount of the plant exterior is covered, and an advanced stage in which an occurrence of prevalent mold in the crops. All environmental parameters were met in accordance with the treatment protocols described above in order to evaluate the treatment as a curative and a preventative therapy, as well as a form of immunotherapy.

The results of the experiments showed that if the synergistic horticultural treatments were initiated with seedlings, and carried out within about 1 hr. after the morning watering of the plant beds, and within about 1 hr. before sunset, no mold was detected. Plants were healthy before harvest. At the same time, an improvement in taste indices and an increase in the smell of fruits were noted. Since this was not the subject of the designated experiments, comparative profile analyses were not conducted.

It is difficult to determine the depth of an affected area of the plants. Growers prefer to clean the affected areas, but the likelihood of spread is quite high. A focus is a patch of crop with plant disease limited in time and space. The experiments showed that after removing the foci of the affected areas, the synergistic horticultural treatments significantly improved the condition of the crop, preventing the mold from spreading. Such treatments were carried out twice a day—about 1 hr. after watering and about 1 hr. before sunset.

While the present invention has been described with respect to a limited number of embodiments, it will be appreciated that many variations, modifications, equivalent structural elements, combinations, sub-combinations, and other applications of the present invention may be made.

What is claimed is:

1. A system for synergistic horticultural regimens using controlled wind and light exposure for strengthened, plant immune systems and plant fungi treatments, the system comprising:
(a) at least one LED lighting system for facilitating prescribed light exposure regimens, capable of achieving a high Photon Flux Density (PFD) at various desirable wavelengths;
(b) at least one controllable fan unit for modulating a controlled breeze of forced air flow in a controlled environment having an ambient temperature and relative humidity (RH) in the vicinity of at least one plant;
(c) at least one sensor unit for monitoring and regulating said ambient temperature and said RH;
(d) a remote controller for regulating wind and lighting parameters by measuring and regulating said at least one LED lighting system, said at least one controllable fan unit, and said at least one sensor unit, said remote controller configured for:
(i) exposing said at least one plant to said controlled breeze in order to cause swaying of said at least one plant to induce microcracks in said at least one plant;
(ii) exposing said at least one plant to a first light regimen in a spectral region of about 360-445 nm to stimulate exudate formation in said at least one plant;
(iii) concurrent with said first light regimen, increasing said ambient temperature to about 22-32° C.;
(iv) removing said controlled breeze after the exterior surfaces of said at least one plant are mostly covered with an exudate;
(v) exposing said at least one plant to a second light regimen in spectral regions of about 360-445 nm and about 425-480 nm to stabilize internal plant processes and to inhibit growth in order to maximize spread and uniform distribution of said exudate;
(vi) subsequent to said removing, reducing said ambient temperature to about 22-25° C.;
(vii) subsequent to said removing, reducing said RH to about 30-60%; and
(viii) exposing said at least one plant to a third light regimen in spectral regions of about 650 nm and about 730 nm to cause said exudate to release oxygen during hardening of said exudate on said at least one plant.

2. The system of claim 1, wherein said controlled environment is adapted to be maintained with said ambient temperature in the range of about 20-22° C. and with said RH in the range of about 40-80%.

3. The system of claim 1, wherein said first light regimen has an exposure time of about 10 minutes.

4. The system of claim 3, wherein said increasing is adapted to maintain said ambient temperature for a duration equivalent to said exposure time.

5. The system of claim 1, wherein said second light regimen has an exposure time of at least about 15-30 minutes.

6. The system of claim 1, wherein said reducing said ambient temperature and said reducing said RH is performed within about 30 minutes of said removing.

7. The system of claim 1, wherein said third light regimen has an exposure time of at least about 30 minutes.

8. The system of claim 7, wherein said remote controller is further configured for:
(ix) exposing said at least one plant to a fourth light regimen in a spectral region of about 730 nm for about 18-33 minutes longer in duration than said exposure time.

9. A method for synergistic horticultural regimens using controlled wind and light exposure for strengthened, plant immune systems and plant fungi treatments, the method comprising the steps of:
(a) providing at least one plant in a controlled environment for regulating wind and light exposure at an ambient temperature and relative humidity (RH) in the vicinity of said at least one plant;
(b) exposing said at least one plant to a controlled breeze in order to cause swaying of said at least one plant to induce microcracks in said at least one plant;
(c) exposing said at least one plant to a first light regimen in a spectral region of about 360-445 nm to stimulate exudate formation in said at least one plant;
(d) concurrent with said first light regimen, increasing said ambient temperature to about 22-32° C.;
(e) removing said controlled breeze after the exterior surfaces of said at least one plant are mostly covered with an exudate;
(f) exposing said at least one plant to a second light regimen in spectral regions of about 360-445 nm and about 425-480 nm to stabilize internal plant processes and to inhibit growth in order to maximize spread and uniform distribution of said exudate;
(g) subsequent to said step of removing, reducing said ambient temperature to about 22-25° C.;
(h) subsequent to said step of removing, reducing said RH to about 30-60%; and
(i) exposing said at least one plant to a third light regimen in spectral regions of about 650 nm and about 730 nm to cause said exudate to release oxygen during hardening of said exudate on said at least one plant.

10. The method of claim 9, wherein said controlled environment is adapted to be maintained with said ambient temperature in the range of about 20-22° C. and with said RH in the range of about 40-80%.

11. The method of claim 9, wherein said first light regimen has an exposure time of about 10 minutes.

12. The method of claim 11, wherein said step of increasing is adapted to maintain said ambient temperature for a duration equivalent to said exposure time.

13. The method of claim 9, wherein said second light regimen has an exposure time of at least about 15-30 minutes.

14. The method of claim 9, wherein said step of reducing said ambient temperature and said step of reducing said RH is performed within about 30 minutes of said step of removing.

15. The method of claim 9, wherein said third light regimen has an exposure time of at least about 30 minutes.

16. The method of claim 15, the method further comprising the step of:
(j) exposing said at least one plant to a fourth light regimen in a spectral region of about 730 nm for about 18-33 minutes longer in duration than said exposure time.
